(19) United States
(12) Patent Application Publication
(10) Pub. No.: US 2009/0227540 A1
(43) Pub. Date: Sep. 10, 2009

(54) TREATMENT OF WOOD BASED ON NOVEL FORMULATIONS OF BORATRANES

(75) Inventors: Peter James Hayward, New Plymouth (NZ); Wallace James Rae, New Plymouth (NZ); Robert Arthur Franch, Rotorua (NZ)

Correspondence Address: OBLON, SPIVAK, MCCLELLAND MAIER & NEUSTADT, P.C., 1940 DUKE STREET, ALEXANDRIA, VA, 22314, US

(73) Assignee: Tapuae Partnership, New Plymouth (NZ)

(21) Appl. No.: 12/095,789

(22) PCT Filed: Dec. 4, 2006
(86) PCT No.: PCT/NZ06/00315

§ 371 Date: Jan. 28, 2009

(30) Foreign Application Priority Data
Dec. 2, 2005 (NZ) 543904

(51) Int. Cl. A01N 55/08; A01P 3/00; A01P 7/04

(52) U.S. Cl. 514/64

(57) ABSTRACT

A wood preservative composition comprising leach resistant boron in the form of a boratrane, and a synergistic proportion of quaternary ammonium compound. The composition can include triadimefon in synergistic proportions with the boratrane and quaternary ammonium compound. It can be in the form of a stable water dilutable composition and include an insoluble fungicide or an insecticide. The composition has the property of providing decay and insect resistance to wood, reconstituted wood fibers and flake and veneer products.

### BACKGROUND OF THE INVENTION

This invention relates to wood preservatives based on novel formulations of boratranes.

Wood as a versatile low cost material and a renewable resource has many advantages in the building trade as a light relatively high strength structural material. However, wood and especially pinus spp has limited durability. To last for many years in service it must be protected against fungi, woodworm termites, and various boring insects. Traditional treating preservatives are mixed aqueous salts of copper chrome and arsenic, soluble boron salts, combinations of quaternary ammonium compounds and copper, azole and copper, oil soluble copper naphthenates, pentachlorophenol, tributyl tin compounds and the like.

In recent years the trend has been towards more benign preservatives with lower mammalian toxicity and lower environmental impact. The use of arsenic and chromium is now being restricted or banned from certain use commodities. This has created renewed interest in more benign wood preservatives such as boric acid and alkyl ammonium compounds.

Alkyl ammonium compounds which include the class of quaternary ammonium compounds and fatty amine salts have been known to be preservatives of excellent cost effectiveness in laboratory tests, but have proved less successful in service due to a poor spectrum of activity or leaching of the active ingredient from the wood surface, or a combination of the two. However, when combined with copper the “ACQ” formulation has gained acceptance over a range of hazard categories including continuous exposure to the weather.

As a water soluble treatment ACQ formulations can be used in the preferred aqueous vacuum pressure treatment processes. However, a deep brownish green colour is imparted to the wood. Also it is necessary to add to the formulation excess of copper complexing ligand in the form of ammonia or ethanolamine to stabilise the copper at use dilution concentrations. Such concentrations increase the ammonical emmisions and alkalinity of the treating solution and treated lumber.

Boron, in the form of its acid or its salts, is a colourless wood treatment with low mammalian toxicity and a broad spectrum of activity. A review of boron treatments and their efficacy data for fungi and termites was presented by Drysdale in a paper presented at the 25^{th} IRG Annual Meeting in Bali, Indonesia (IRGWP-94-30037). Aqueous boric salts have a 40 to 50 year history as cost effective preservatives.

A major limitation of boric acid and its octoborate salts are their solubility and thus tendency to leach in situations of continuous exposure to the weather. Leaching has limited its use to the interior protection of framing and flooring against insect attack and opportunist fungal decay when intermittantly wet. Boron treatments can still be used for exterior weatherboard or window framing where the wood is additionally protected by paint. However, painting does not appear to give protection at lesser retentions of boron treatment against termites, and a retention of at least 4 kg/m³ boric acid equivalent is required to give full protection against Coptotermes formosanus. (Preston IRG/WP/2241)

Traditional treatment procedures involve applying: concentrated solutions of mobile ions such as boron to wet wood and allowing time for these to diffuse throughout the solid wood product; deeply penetrating vacuum pressure treatments of solid wood products; or for products which are all ready assembled in final form, a low pressure organic solvent process is sometimes appropriate.

Vapour impregnation with volatile trimethylborate has recently been described by Nasheri (U.S. Pat. No. 5,871,817) but has yet to gain commercial acceptance. Treatment of solid freshly sawn wood by dipping in concentrated boron salts and storing until diffusion has taken place, is still practiced. All such boron treatments, however, are not fixed.

In view of the many characteristics which make boron an attractive wood treatment biocide, a number of attempts have been made to improve the fixation properties of the treatment. Simple borate esters may be formed and dissolved in a nonaqueous carrier but are rapidly hydrolysed back to boric acid. A similar approach has been to employ lipophillic ligands which are more resistant to hydrolysis and that will contibute greater fungal activity than that due to the boric acid alone.

Maynard (U.S. Pat. No. 5,221,758) has prepared spiro-borate complexes from a chlorinated nonyl-2-hydroxybenzyl alcohol. He has shown that it is possible to include copper as a counter ion to the complex in a hydrocarbon solvent. These complexes have been proven as effective preservatives in field trials.

Humphrey et al has extended this approach with more readily available intermediates. They prepared separately the spiro-borate complexes of 2-hydroxybenzyl alcohol and salicylic acid and precipitated both as their tetra-n-butylammonium salts. The spiro-borate complex of 2-hydroxybenzyl alcohol showed complete inhibition of the fungi P. tephropora and G. abietinum. In each case fixation is reliant on low water solubility. Treatment processes therefore will be limited to those that use the preservative in a hydrocarbon carrier.

A promising approach to the fixation of boron has recently been described by Franich (NZ Patent 514356). Although in general boric acid esters are rapidly hydrolysed, the tri esters of trialkanolamines are more hydrolytically stable. It is thought that boron has a weak transannular bond with the nitrogen atom which holds it in a conformation well shielded from attack by hydrolytic molecules. Tri-isopropanolamine boratrane for example has a half life for hydrolysis of 171 days (Kirk-Othmer, Encyclopedia of Chemical Technology 2^{nd} Ed., Vol 3 pg. 690). These boratranes are generally soluble in water acetone and alcohols and slightly soluble in aromatic hydrocarbons.

It is possible to further alter solubility of the tri-isopranolamine boratrane by attaching an alkyl sidechain to the basic boratrane structure. The 3,7-dimethyl-10-decyl-2,8,9-trioxa-5-aza-1-boratricyclo-[3.3.3.0]-undecane (hence forth called decyl isopropanolamine boratrane) has been synthesised by Franich and co-workers.

Lap joints placed in horizontal racks outside have demonstrated the superior efficacy of this compound when compared to boric acid in a weather exposed environment. The low aqueous solubility ensures a degree physical fixation while the slow hydrolysis of the parent molecule ensures a steady release of boric acid. By analysis of the lap joints each year a rate of boron leaching has been established as significantly lower than boric acid. However, the compound contains only about 19%-20% w of boric acid equivalent. To reach a boric acid retention of 1% (4.5 kg/m³ bae) thus requires a treating solution strength of about 5% decyl isopropanolamine boratrane.

A disadvantage of the decyl isopropanolamine boratrane is that it does not immediately lend itself to aqueous treatments. For solutions to remain stable indefinitely decyl isopropanolamine boratrane must be in ethanolic or aqueous ethanolic solutions where the ethanol is greater than 10% of the diluting phase.

Glued wood products are often preserved by adding biocides during the process either by dipping the veneer, adding to the glueline or in the case of chip and fibre board, injecting into the furnish prior to pressing. Unfortunately boron, a preferred low cost preservative for products used internally and traditionally applied as boric acid or octaborate, cannot be applied by any of the above means due to its reaction with glue systems causing poor glue bonding. A degree of resin compatibility may be achieved by including sparingly soluble zinc or calcium borate in the furnish. However, the addition rates required for fungal and termite protection, about 1% of the wood mass, are at the limits of compatibility of these boron salts with the glue. Care, and specially formulated glue powders, are required to avoid compromising the internal bond strength of the finished board.

Sy Trek Sean describes in U.S. Pat. No. 5,763,338, a method by which up to 10% of a low solubility borate, in particular Zinc borate, may be added to the furnish, provided a resin “flow agent” is used. In the examples used to illustrate the method, polyethylene glycol 400 is used in proportion to the amount of Zinc borate added. The presence of PEG 400 with the resin, minimised the premature gelling of the glue prior to pressing. It is noted that to meet the CSA requirements for the board strength at the higher Zinc borate levels, more resin is required and the strength properties of the board were still less than the control with no Zinc borate. Thus to extend the concentration of boron beyond 1% requires higher resin use and the use of additional additives.

One undiscovered aspect of boratranes are their improved compatibility with the resins employed in the manufacture of engineered wood products. In particular, the phenol formaldehyde resins used in plywood manufacture. By this aspect of the present invention it has been found that concentrated solutions of boratrane may be applied to dry veneers with minimal or no drying just prior to application of the glue. It has been found the boratranes described in this invention, thus applied, do not materially affect the glue bond. It is also anticipated that compositions of boratrane described in this invention suitably formulated may also be advantageously thus applied.

### SUMMARY OF THE INVENTION

An object of the present invention is to provide an improved boron wood preservative which exhibits favourable activity against wood destroying fungi and insects, which is less readily leached and may be applied primarily in aqueous solution.

A further object of this invention is to provide an improved boron wood preservative which exhibits synergistic activity against wood destroying fungi and insects, allowing more economical rates of unleached boron to be effective.

A further object of this invention is to provide an improved boron wood preservative which may be advanteously applied to the surfaces of wood in glued wood products, in sufficient quantities to provide fungicidal and insecticidal protection, without materially altering bond strength or wood moisture content.

According to one aspect of the invention there is provided a composition comprising leach resistant boron in the form of a boratrane, and a synergistic proportion of quaternary ammonium compound having the property of providing decay and insect resistance to wood, reconstituted wood fibers and flake and veneer products.

Preferably the composition further includes triadimefon in synergistic proportions with the boratrane and quaternary ammonium compound.

Preferably the composition is in the form of a stable water dilutable composition and includes insoluble fungicide or an insecticide.

### DETAILED DESCRIPTION OF PREFERRED EMBODIMENTS OF THE INVENTION

The present invention thus concerns wood preservatives based on the mixtures of boratranes and quaternary ammonium compounds and optionally the addition of a water insoluble fungicide and/or insecticide.

Preferably the quaternary ammonium is a dialkyl dimethyl quaternary ammonium salt, an alkyl dimethyl ammonium salt an alkyl trimethyl quaternary ammonium salt, an alkyl dimethyl benzyl quaternary ammonium salt, a dialkylmethyl benzyl quaternary ammonium salt, an alkyl and dialkyl oxyethylene methyl quaternary ammonium salt, a methyl and benzyl bishydroxyethyl quaternary ammonium salt, or a polymeric quaternary ammonium compound.

Preferably the fungicide can be an azole: such examples being propiconazole, tebuconazole, cyproconazole, triadimenol, tebuconazole, hexaconazole; or other miscible fungicides such as fluazinam. The insecticide can preferably be a neonicotinoid: such examples being imidacloprid, or acetamiprid or a synthetic pyrethroid: such examples being permethrin, deltamethrin, cypermethrin, or bifenthrin.

Preferably the higher alkyl isopropanolamine boratranes of very limited water solubility form a surprisingly stable aqueous solution when combined with alkyl ammonium compounds.

Preferably the fungicides in mixture show a more than additive activity to wood rotting fungi.

Simple preparations of novel leach resistant preservatives incorporating alkyl isopropanolamine boratrane and alkylammonium compounds are described. The higher alkyl isopropanolamine boratranes are of very limited water solubility but form surprisingly stable solutions when combined with alkylammonium compounds. The water dilutable preparations thus formed show for example, synergistic activity when tested against the white rots P. coccineus and T. versicolor.

A further benefit of such formulations is the simplicity of preparation and the ability to incorporate other water insoluble co-actives. We have discovered that the inclusion of certain azole fungicides generate a surprising increase in activity against not only the aforementioned white rots but also brown rots.

It is shown that according to the present invention boron captured in an alkyl boratrane and formulated with the alkyl ammonium compound will not be readily leached when formulated in this mixture. It is also shown that the boron in the form of a boratrane and when mixed with alkylammonium compound will exhibit more favourable activity against wood destroying fungi than is the case with boratrane alone.

It is further shown that the addition of a water insoluble fungicide will further enhance and synergise the activity of the combined boratrane and quaternary ammonium compound.

Simple preparations of novel leach resistant boratrane preservatives incorporating boratrane as a glycol or alcohol soluble formulation with certain alkyl ammonium compounds are described. The mixtures thus formed are soluble as micro-emulsions in water but are surprisingly still fixed when impregnated in wood. The mixtures thus formed show increased activity against Pycnoporus coccineus and Trametes versicolor compared to the simply additive activity of boric acid or alkyl ammonium compound on its own. A further benefit of such mixtures is the simplicity of preparation and the ability to incorporate other water insoluble co-actives.

According to an embodiment of the invention alkyl boratrane is dissolved in glycol solvent and then solubilised with a variety of quaternary ammonium compounds. The resulting preparations can be used as a carrier for water insoluble organic solvents and other water insoluble fungicides e.g. azole fungicides, which further synergises the activity of the combined alkyl ammonium compound and boratrane. Such preparations may then be diluted to form stable micro-emulsions which may be used to treat wood or wood composites.

Of the quaternary compounds which may be used in the compositions and methods of the present invention, suitable compounds include:

1. General alkyl quaternaries

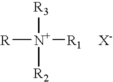

where R and R₁, R₂ and R₃ are the same or different and may be H, C₁ to C₁₈ alkyl or C₁ to C₄ alkyl and X— is an anion chosen to allow ready water solubility of the quaternary ammonium salt. Examples being chloride, bromide, methosulphate, acetate, propionate, lactate and carbonate.

Preferred examples include cocotrimethyl ammonium chloride in which R₁, R₂ and R₃ are methyl groups and R consists predominatly of a mixture of C₁₂, C₁₄ and C₁₆.

Dialkyl dimethyl ammonium salts wherein R₂ and R₃ are methyl and R and R₁ may be the same or different and contain between 6 and 18 carbon atoms and preferrably between 8 and 16 carbon atoms. Preferred examples include didecyl dimethyl ammonium chloride, dioctyl dimethyl ammonium chloride and octyl decyl dimethyl ammonium chloride and dicoco dimethyl ammonium chloride where the alkyl groups R and R₁ consist predominantly of C₁₂ to C₁₄ alkyl.

2. Alkyl dimethyl benzyl ammonium salts and dialky methyl benzyl ammonium salts. Wherein R₂ is benzyl and R₃ is methyl, and R and R₁ may be the same or different and contain between 6 and 18 carbon atoms and preferrably between 8 and 10 carbon atoms; or R₂ is benzyl or alkyl benzyl and R₁, R₃ are methyl, and R may contain between 8 and 18 carbon atoms and preferably between 12 and 16 carbon atoms. Preferred examples include coco benzyl dimethyl ammonium chloride and dicoco benzyl methyl ammonium chloride.
3. Alkyl and dialkyl oxyethylene methyl ammonium salts of the formula:

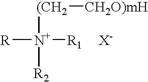

wherein R and R₁ are alkyl groups which may be the same or different and contain between 6 and 18 carbon atoms and preferrably between 8 and 10 carbon atoms, R₂ is methyl and m is a number between 1 and 20 and typically between 1 and 8. X— is an anion previously described, preferably a propionate or lactate; or R₁ and R₂ are methyl and R is an alkyl group between 8 and 16 carbon atoms and m is a number between 1 and 20 and typically between 1 and 8. Preferred examples include N,N-didecyl-N-methyl-poly(oxyethyl) ammonium propionate (Bardap 26).
4. Methyl and benzyl bishydroxyethyl ammonium salts of the formula:

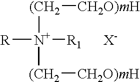

Wherein R is alkyl group which may contain between 8 and 18 carbon atoms and preferrably between 12 and 16 carbon atoms, R₁ is methyl and m is a number between 1 and 5 and typically 1. X— is an anion previously described, preferably a chloride; or R₁ is a benzyl moeity and R is an alkyl group between 8 and 16 carbon atoms.
5. Polymeric quaternary ammonium compounds in which active quaternary ammonium compounds are grafted to a polymer backbone. Preferred examples include Busan WSCP.

Examples of alkyl boratranes suitable for this purpose are those of the general formula:

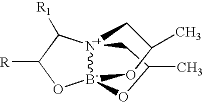

wherein R may be an alkyl from C₁ to C₁₈ or an aryl or an alkyl aryl moeity, while R₁ may be H or an alkyl C₁ to C₁₈. Preferred examples include adducts of epoxidised oleate esters boric acid and di-isopropanolamine. Particularly preferred is: 3,7-dimethyl-10-decyl-2,8,9-trioxa-5-aza-1-boratricyclo-[3.3.3.0]-undecane.

Boratranes which have been derived from epoxidized vegetable oils

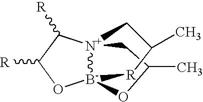

wherein R represents the triglyceride backbone of a fatty oil. Particularly preferred boratranes are the adducts of boric acid, di-isopropanolamine and an epoxidized vegetable oil. Particularly preferred is the boratrane derived from epoxidized soyabean oil

Examples of azole fungicides suitable for formulating with the above mixtures are:

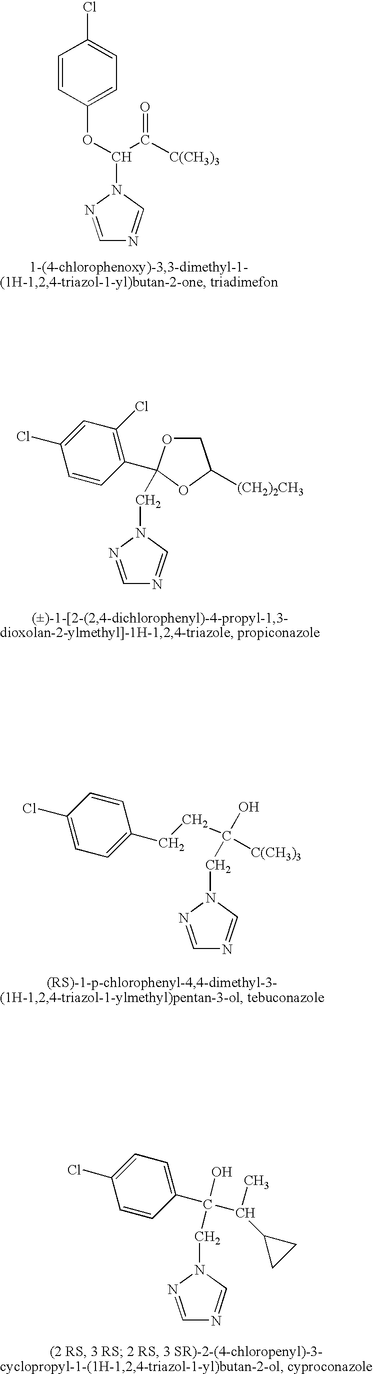

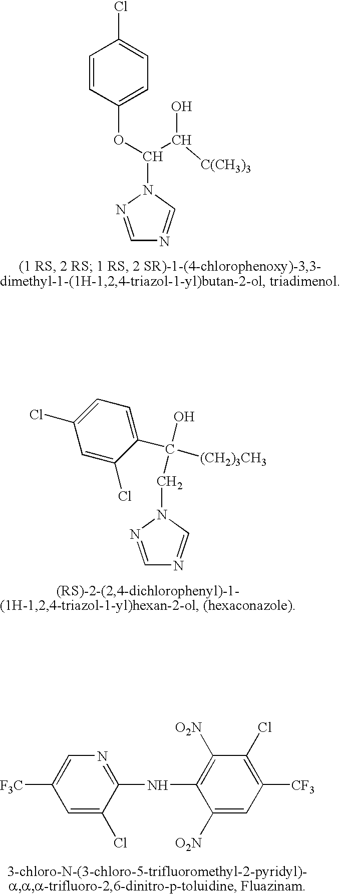

The novel preservative agents have a pH from 6 to 8.5 preferably from 6.5 to 7.5 in aqueous solutions.

The concentrates contain from 2 to 20% by weight of boric acid equivalent in the form of 5 to 60% by weight of alkyl boratrane, from 1 to 80% of alkylammonium compound and 0 to 80% by weight of glycol, glycol ether or alkylene diglycol or C₁ to C₄ alcohol and optionally from 1 to 20% of an additional water insoluble preservative

The present invention thus embraces the impregnation of solutions of alkyl ammonium salts or of the salts used as carriers for other water insoluble fungicides which can be prepared as an emulsion, preferably a micro-emulsion. In either case dilution with water can be readily achieved and thus be conveniently applied to veneer, solid wood or wood fibre by any of the common processes used in wood and fibre preservation.

### Comparative Example

Decyl isopropanolamine boratrane 15 gm is dissolved with warming in 35 g of butoxyethanol 40.15 g of water. The volume was made up to 100 ml with water. This formulation when diluted 1:30 initially formed a stable clear solution. On standing for 12 hours a cloudy precipitate formed.

### Example 1

Decyl isopropanolamine boratrane 15 gm is dissolved with warming in 35 g of butoxyethanol 40.15 g of water and 6.25 g of didecyldimethyl ammonium chloride 80% concentrate. Finally the volume was made up to 100 ml with water. This formulation when diluted 1:30 formed a stable clear solution.

### Example 2

Triadimefon 95% 3.16 gm is dissolved with warming in butoxyethanol 35 g and terpineol 25 g. Decyl isopropanolamine boratrane 15 g and didecyldimethyl ammonium chloride 80% concentrate 6.25 g is then added and dissolved. Finally the emulsifiers Teric 200 5 g, Soprophor BSU 5 g and water 5.59 g, are added to make 100 g of formulation. This formulation when diluted 1:30 formed stable clear solutions.

### Example 3

Cyproconazole 95% 5.26 gm is dissolved with warming in butoxyethanol 35 g. Decyl isopropanolamine boratrane 15 g and didecyldimethyl ammonium chloride 80% concentrate 6.25 g and water 33.49 g are then added and dissolved. Finally the emulsifier Teric 200 5 g is added to make 100 g of formulation. This formulation when diluted 1:30 formed stable clear solutions.

### Example 4

Tebuconazole 93% 5.4 gm is dissolved with warming in butoxyethanol 35 g. Decyl isopropanolamine boratrane 15 g and didecyldimethyl ammonium chloride 80% concentrate 6.25 g and water 33.35 g are then added and dissolved. Finally the emulsifier Teric 200 5 g is added to make 100 g of formulation. This formulation when diluted 1:30 formed stable clear solutions.

### Example 5

Hexaconazole 93% 5.4 gm is dissolved with warming in butoxyethanol 35 g. Decyl isopropanolamine boratrane 115 g and didecyldimethyl ammonium chloride 80% concentrate 6.25 g and water 33.35 g are then added and dissolved. Finally the emulsifier Teric 200 5 g is added to make 100 g of formulation. This formulation when diluted 1:30 formed stable clear solutions.

### Example 6

Propiconazole 95% 5.26 gm is dissolved with warming in butoxyethanol 35 g. Decyl isopropanolamine boratrane 15 g and didecyldimethyl ammonium chloride 80% concentrate 6.25 g and water 33.49 g are then added and dissolved. Finally the emulsifier Teric 200 5 g is added to make 100 g of formulation. This formulation when diluted 1:30 formed stable clear solutions.

### Example 7

This example demonstrates the synergism of the combinations of didecydimethyl ammonium chloride and decyl isopropanolamine boratrane when tested on white rot fungi and a degree of antagonism when tested on brown rot fungi. To this end an alcoholic aqueous solutions of decyl boratrane and didecyldimethyl ammonium chloride were prepared separately and in combination in a ratio of 3:1 Serial dilutions of the formulations of the respective fungicides and fungicide mixture were added to 3 replicate plates of malt agar under aseptic conditions. Three replicate control plates without fungicide were similarly prepared.

Onto each plate was placed 6 fungal inoculum squares measuring approximately 5×5 mm. The plates were incubated at 25° C. until the control plate cultures showed signs of consistent growth—about 48 hours. The plates were then rated for growth inhibition and the results recorded.

TABLE 1

| | Fungi | | |
|---|---|---|---|
| | Tyromyces palustris | | |
| Rate | Actives | | |
| ppm | DIPB^{a} | Ratio 3:1 | DDAC |
| 1024 | end point | + | end |
| | | | point |
| 512 | + | + | + |
| 256 | + | + | + |
| 128 | + | + | + |
| 64 | + | + | + |
| 32 | + | + | + |
| 16 | + | + | + |
| 8 | + | + | + |
| 0 | + | + | + |
| MIC | 1024 | >1024 | 1024 |

^{a}DIPB, Decyl isopropanolamine boratrane

TABLE 2

| | Fungi | | |
|---|---|---|---|
| | Fomitopsis lilacino-gilva | | |
| Rate | Actives | | |
| ppm | DIPB | Ratio 3:1 | DDAC |
| 1024 | ± | growth | |
| 512 | + | + | |
| 256 | + | + | end point |
| 128 | + | + | + |
| 64 | + | + | + |
| 32 | + | + | + |
| 16 | + | + | + |
| 8 | + | + | + |
| 0 | + | + | + |
| MIC | 2048 | >1024 | 256 |

TABLE 3

| | Fungi | | |
|---|---|---|---|
| | Antroda xantha | | |
| Rate | Actives | | |
| ppm | DIPB | Ratio 3:1 | DDAC |
| 1024 | | | |
| 512 | | | |
| 256 | end point | end point | end point |
| 128 | + | + | + |
| 64 | + | + | + |
| 32 | + | + | + |
| 16 | + | + | + |
| 8 | + | + | + |
| 0 | + | + | + |
| MIC | 256 | 256 | 256 |

TABLE 4

| | Fungi | | |
|---|---|---|---|
| | Trametes versicolor | | |
| Rate | Actives | | |
| ppm | DIPB | Ratio 3:1 | DDAC |
| 1024 | | | + |
| 512 | | | + |
| 256 | end point | | + |
| 128 | + | | + |
| 64 | + | end point | + |
| 32 | + | + | + |
| 16 | + | + | + |
| 8 | + | + | + |
| 0 | + | + | + |
| MIC | 256 | 128 | >1024 |

TABLE 5

| | Fungi | | |
|---|---|---|---|
| | Pycnoporus coccineus | | |
| | Actives | | |
| Rate | DIPB | Ratio 3:1 | DDAC |
| 1024 | ± | end point | ± |
| 512 | + | ± | + |
| 256 | + | + | + |
| 128 | + | + | + |
| 64 | + | + | + |
| 32 | + | + | + |
| 16 | + | + | + |
| 8 | + | + | + |
| 0 | + | + | + |
| MIC | 2048 | 1024 | 2048 |

The absence or presence of synergism may be calculated by the method of F. C. Kull et al., Applied Microbiology, Vol 9, (1961) p 538 et seq. The synergistic index (S.I.) is calculated according to the following formula.

S.I.=Qa/QA+Qb/QB

In the present context the parameters in the formula have the following meaning:

Qa=The concentration of compound decyl isopropanolamine boratrane (compound A) in mixture which produces and end point.
Qb=The concentration of compound didecyldimethyl ammonium chloride (compound B) in mixture which produces and end point.
QA=The concentration of compound decyl isopropanolamine boratrane (compound A) alone which produces and end point.
QB=The concentration of compound didecyldimethyl ammonium chloride (compound B) alone which produces and end point.
QC=The concentration of the mixture of didecyldimethyl ammonium chloride and decyl isopropanolamine boratrane (compounds A+B) which together produces and end point.

If the synergistic index is above 1, this means that antagonism is present. If the synergistic index equals 1, this means that an additive effect of the two biocides exist. If the synergistic index is less than 1, this means that synergism of the two biocides exist.

Tables 1 to 5 record the end points of the mixtures which are interpreted as the fungal minimum inhibitory concentrations. Table 6 summarises the data and calculation. Tables 1 to 3 show that no synergism exists when tested against the three brown rot fungi: Tyromyces palustris, Fomitopsis lilacino-gilva, and Antroda xantha. However, when the mixture is tested against the white rot fungi Pycnoporus coccineus & Trametes versicolor it can be seen in Tables 4 and 5 that the minimum inhibitory concentration of the mixture of didecyldimethyl ammonium chloride and decyl isopropanolamine boratrane is lower than either the didecyldimethyl ammonium chloride or the decyl boratrane by themselves at comparable concentrations.

TABLE 6

| | Ratio | End Point Concentrations | | | | | Calculations | | |
|---|---|---|---|---|---|---|---|---|---|
| Fungi | A:B | QA | QB | QC | Qa | Qb | Qa/QA | Qb/Qb | SI |
| Tyromyces palustris | 3:1 | 1024 | 1024 | 2048 | 1536 | 512 | 1.50 | 0.50 | 2.0 |
| Fomitopsis lilacino- | 3:1 | 2048 | 256 | 2048 | 1536 | 512 | 0.75 | 2.00 | 2.8 |
| gilva | | | | | | | | | |
| Antroda xantha | 3:1 | 256 | 256 | 256 | 192 | 64 | 0.75 | 0.25 | 1.0 |
| Pycnoporus | 3:1 | 256 | 2048 | 128 | 96 | 32 | 0.38 | 0.02 | 0.4 |
| coccineus | | | | | | | | | |
| Trametes versicolor | 3:1 | 2048 | 2048 | 1024 | 768 | 256 | 0.38 | 0.13 | 0.5 |

### Example 8

This example demonstrates the synergism of the 3:1 mixture of decyl isopropanolamine boratrane and didecydimethyl ammonium chloride when tested over a range of brown and white rot fungi. To this end an alcoholic aqueous solution of decyl boratrane and didecyldimethyl ammonium chloride was formulated in a ratio of 3:1. In a separate formulation a micro-emulsion of triadimefon was prepared. Serial dilutions of the formulations of the respective fungicides were added to 3 replicate plates of malt agar under aseptic conditions and tested for synergism under the same conditions as example 7 at ratios of 10:1 and 20:1 boratrane didecyldimethyl ammonium chloride mixture to 1 of triadimefon.

TABLE 7

| | Fungi | | | |
|---|---|---|---|---|
| | Tyromyces palustris | | | |
| | Actives | | | |
| Rate | DIPB | | | |
| ppm | DDAC 3:1 | 20:1 | 10:1 | Triadimefon |
| 2048 | end point | | | |
| 1024 | + | | | |
| 512 | + | | | |
| 256 | + | | | |
| 128 | + | end point | end point | |
| 64 | + | + | + | |
| 32 | + | + | + | end point |
| 16 | + | + | + | + |
| 8 | + | + | + | + |
| 4 | + | + | + | + |
| 2 | + | + | + | + |
| 1 | + | + | + | + |
| 0.5 | + | + | + | + |
| MIC | 2048 | 128 | 128 | 32 |

TABLE 8

| | Fungi | | | |
|---|---|---|---|---|
| | Trametes versicolor | | | |
| | Actives | | | |
| Rate | DIPB | | | |
| ppm | DDAC 3:1 | 20:1 | 10:1 | Triadimefon |
| 2048 | + | | | |
| 1024 | + | | | |
| 512 | + | | | |
| 256 | + | | | |
| 128 | + | | | |
| 64 | + | | | |
| 32 | + | | | end point |
| 16 | + | end point | end point | + |
| 8 | + | + | + | + |
| 4 | + | + | + | + |
| 2 | + | + | + | + |
| 1 | + | + | + | + |
| 0.5 | + | + | + | + |
| MIC | >2048 | 16 | 16 | 128 |

TABLE 9

| | Fungi | | | |
|---|---|---|---|---|
| | Antroda xantha | | | |
| | Actives | | | |
| Rate | DIPB | | | |
| ppm | DDAC 3:1 | 20:1 | 10:1 | Triadimefon |
| 2048 | | | | |
| 1024 | | | | |
| 512 | | | | |
| 256 | end point | | | |
| 128 | + | | | |
| 64 | + | | | |
| 32 | + | end point | end point | |
| 16 | + | + | + | |
| 8 | + | + | + | |
| 4 | + | + | + | end point |
| 2 | + | + | + | + |
| 1 | + | + | + | + |
| 0.5 | + | + | + | + |
| MIC | 256 | 32 | 32 | 4 |

TABLE 10

| | Fungi | | | |
|---|---|---|---|---|
| | Fomitopsis lilacino-gilva | | | |
| | Actives | | | |
| Rate | DIPB | | | |
| ppm | DDAC 3:1 | 20:1 | 10:1 | Triadimefon |
| 2048 | | | | |
| 1024 | end point | | | |
| 512 | + | | | |
| 256 | + | | | |
| 128 | + | | | |
| 64 | + | end | end | |
| | | point | point | |
| 32 | + | + | + | |
| 16 | + | + | + | |
| 8 | + | + | + | |
| 4 | + | + | + | end point |
| 2 | + | + | + | + |
| 1 | + | + | + | + |
| 0.5 | + | + | + | + |
| MIC | 1024 | 64 | 64 | 4 |

TABLE 11

| | Fungi | | | |
|---|---|---|---|---|
| | Pycnoporus coccineus | | | |
| | Actives | | | |
| Rate | DIPB | | | |
| ppm | DDAC 3:1 | 20:1 | 10:1 | Triadimefon |
| 2048 | | | | |
| 1024 | end point | | | |
| 512 | + | | | |
| 256 | + | | | |
| 128 | + | | | |
| 64 | + | | | |
| 32 | + | | | |
| 16 | + | end | end | |
| | | point | point | |
| 8 | + | + | + | |
| 4 | + | + | + | end point |
| 2 | + | + | + | + |
| 1 | + | + | + | + |
| 0.5 | + | + | + | + |
| MIC | 1024 | 16 | 16 | 4 |

TABLE 12

| | | End Point Concentrations | | | | | Calculations | | |
|---|---|---|---|---|---|---|---|---|---|
| Fungi | Ratio A:B | QA | QB | QC | Qa | Qb | Qa/QA | Qb/Qb | SI |
| Tyromyces palustris | 10:1 | 2048 | 32 | 128 | 116.36 | 11.64 | 0.057 | 0.36 | 0.42 |
| Fomitopsis lilacino- | 10:1 | 1024 | 4 | 64 | 58.18 | 5.82 | 0.057 | 1.45 | 1.51 |
| gilva | | | | | | | | | |
| Antroda xantha | 10:1 | 256 | 4 | 32 | 29.09 | 2.91 | 0.114 | 0.73 | 0.84 |
| Pycnoporus coccineus | 10:1 | 4096 | 128 | 16 | 14.55 | 1.45 | 0.004 | 0.01 | 0.01 |
| Trametes versicolor | 10:1 | 1024 | 4 | 16 | 14.55 | 1.45 | 0.014 | 0.36 | 0.38 |

TABLE 13

| | | End Point Concentrations | | | | | Calculations | | |
|---|---|---|---|---|---|---|---|---|---|
| Fungi | Ratio A:B | QA | QB | QC | Qa | Qb | Qa/QA | Qb/Qb | SI |
| Tyromyces palustris | 20:1 | 2048 | 32 | 128 | 121.90 | 6.10 | 0.060 | 0.19 | 0.25 |
| Fomitopsis lilacino- | 20:1 | 1024 | 4 | 64 | 60.95 | 3.05 | 0.060 | 0.76 | 0.82 |
| gilva | | | | | | | | | |
| Antroda xantha | 20:1 | 256 | 4 | 32 | 30.48 | 1.52 | 0.119 | 0.38 | 0.50 |
| Pycnoporus coccineus | 20:1 | 4096 | 128 | 16 | 15.24 | 0.76 | 0.004 | 0.01 | 0.01 |
| Trametes versicolor | 20:1 | 1024 | 4 | 16 | 15.24 | 0.76 | 0.015 | 0.19 | 0.21 |

Tables 12 and 13 summarise the data and calculation. It can be seen in Tables 12 and 13 that the synergy of didecyldimethyl ammonium chloride, decyl isopropropanolamine boratrane with triadimefon now extends over the spectrum of white and brown rot fungi at ratio of 10:1 to 20:1 with only a single exception at the 10:1 ratio against Fomitopsis lilacino-gilva.

### Example 9

The synergy experiment in Example 8 was repeated at two additional ratios of 5:1 and 50:1. The results are sumarised in tables 14 and 15.

TABLE 14

| | | End Point Concentrations | | | | | Calculations | | |
|---|---|---|---|---|---|---|---|---|---|
| Fungi | Ratio A:B | QA | QB | QC | Qa | Qb | Qa/QA | Qb/Qb | SI |
| Tyromyces palustris | 5:1 | 2048 | 16 | 32 | 26.7 | 5.3 | 0.013 | 0.33 | 0.35 |
| Fomitopsis lilacino- | 5:1 | 2048 | 8 | 32 | 26.7 | 5.3 | 0.013 | 0.67 | 0.68 |
| gilva | | | | | | | | | |
| Antroda xantha | 5:1 | 512 | 4 | 16 | 13.3 | 2.7 | 0.026 | 0.67 | 0.69 |
| Pycnoporus coccineus | 5:1 | 2048 | 0.5 | 4 | 3.3 | 6.7 | 0.002 | 1.333 | 1.33 |
| Trametes versicolor | 5:1 | 2048 | 4 | 128 | 106.7 | 21.3 | 0.052 | 5.33 | 5.39 |

TABLE 15

| | | End Point Concentrations | | | | | Calculations | | |
|---|---|---|---|---|---|---|---|---|---|
| Fungi | Ratio A:B | QA | QB | QC | Qa | Qb | Qa/QA | Qb/Qb | SI |
| Tyromyces palustris | 50:1 | 2048 | 16 | 256 | 250.98 | 5.02 | 0.123 | 0.31 | 0.44 |
| Fomitopsis lilacino- | 50:1 | 2048 | 8 | 128 | 125.49 | 2.51 | 0.061 | 0.31 | 0.38 |
| gilva | | | | | | | | | |
| Antroda xantha | 50:1 | 512 | 4 | 64 | 62.75 | 1.25 | 0.123 | 0.31 | 0.44 |
| Pycnoporus coccineus | 50:1 | 2048 | 0.5 | 16 | 15.69 | 0.31 | 0.008 | 0.63 | 0.64 |
| Trametes versicolor | 50:1 | 2048 | 4 | 256 | 250.98 | 5.02 | 0.123 | 1.25 | 1.38 |

The data in tables 14 and 15 show that at the more extreme ratios synergism is weaker and less consistent especially against Trametes versicolor.

### Example 10

Decyl isopropanolamine boratrane 15 gm is dissolved with warming in 29.2 g of butoxyethanol 45.95 g of water and 6.25 g of alkyldimethyl benzyl ammonium chloride 80% concentrate. Finally the volume was made up to 100 ml with water. This formulation when diluted 1:30 formed a stable clear solution.

### Example 11

A more rigorous examination of the potential synergism of was carried out on leached wood blocks. Radiata pine blocks were cut to size (20×20×20 mm) and labeled according to treatment level. The blocks were then vacuum impregnated at

−95 kpa with the various treatments as specified in table 16. The aqueous or alcoholic carrier solvents were then allowed to air dry for a period of 5 days. The blocks were then subjected to leaching and biological attack in accordance with the AWPA's “Proctocols for assessment of Wood Preservatives.” The fungal species used were Tyromyces palustris, Coniophora puteana and Fomitopsis lilacino-gilva.

TABLE 16

| | | | | Retenetion |
|---|---|---|---|---|
| Treatment | Active 1 | Retenetion Rate^{a} | Active 2 | Rate |
| Untreated | | | | |
| Formulation | DIPB | 0.1% w boric acid^{b} | ADBAC^{c} | 0.16% w |
| Example 10 | DIPB | 0.2% w boric acid | ADBAC | 0.33% w |
| | DIPB | 0.4% w boric acid | ADBAC | 0.66% w |
| | DIPB | 0.8% w boric acid | ADBAC | 1.33% w |
| decyl boratrane | DIPB | 0.1% w boric acid | | |
| 15% in ethanol | DIPB | 0.2% w boric acid | | |
| | DIPB | 0.4% w boric acid | | |
| | DIPB | 0.8% w boric acid | | |
| Benzalkonium | | | ADBAC | 0.16% w |
| Chloride 50% | | | ADBAC | 0.33% w |
| | | | ADBAC | 0.66% w |
| | | | ADBAC | 1.33% w |
| | Boric acid | 0.4% w boric acid | | |
| | | 0.8% w boric acid | | |

^{a}Treating solutions adjusted to give the nominal w/w retentions
^{b}average retention of boric acid equivalent.
^{c}alkyldimethyl benzyl ammonium chloride, where alkyl = C₁₂ 66% and C₁₄ 33%

TABLE 17

| | | Tyromyces | Coniophora | Fomitopsis | |
|---|---|---|---|---|---|
| | | palustris | puteana | lilacino-gilva | |
| Treatment | Active Retentions^{a} | Mass loss % | Mass loss % | Mass loss % | |
| Untreated | | 25.05 | 52.63 | 31.14 | C |
| Composition | 0.1% w b.a.e., 0.16% ADBAC | 22.22 | 45.61 | 32.58 | C11 |
| Example 10 | 0.2% w b.a.e., 0.33% ADBAC | 18.45 | 34.35 | 12.7 | C2 |
| | 0.4% w b.a.e., 0.66% ADBAC | 1.53 | 5 | 0.25 | C3 |
| | 0.8% w b.a.e., 1.33% ADBAC | 0.7 | 1.87 | 0.21 | C4 |
| DIPB | 0.1% w b.a.e. | 22.55 | 56.25 | 32.95 | A1 |
| DIPB | 0.2% w b.a.e. | 26.55 | 47.62 | 34.58 | A2 |
| DIPB | 0.4% w b.a.e | 21.33 | 27.93 | 10.09 | A3 |
| DIPB | 0.8% w b.a.e | 0.86 | 4.64 | 0.29 | A4 |
| Benzalkonium | ADBAC 0.16% w | 21.68 | 60.59 | 30.66 | B1 |
| Chloride 50% | ADBAC 0.33% w | 25.03 | 48.9 | 29.44 | B2 |
| | ADBAC 0.66% w | 23.72 | 39.16 | 27.92 | B3 |
| | ADBAC 1.33% w | 12.61 | 17.72 | 4.27 | B4 |
| | Boric acid 0.4% w | 23.66 | 47.37 | 32.91 | D1 |
| | Boric acid 0.8% w | 24.67 | 43.4 | 30.6 | D2 |

^{a}Treating solutions adjusted to give the nominal w/w retentions
There is sufficient data in Table 17 to calculate the synergism for the decyl isopropanolamine boratrane and alkyldimethyl benzyl ammonium chloride using the method described by Colby (Colby SR, Calculating synergistic and antagonistic responses of herbicide combinations. Weeds 15:20 ± 22 (1967)) The expected inhibition from a linear response may be calculated. from the equation E = X + Y − XY/100. Where X is the % inhibition of growth (compared to control) by the fungicide A at retention p, and Y is the %

inhibition of growth by fungicide B at retention q. E is the expected additive inhibition of the two fungicides. If a greater inhibition occurs with the combined treatment than the two fungicides acting alone synergism is defined to be present.

Synergy is best demonstrated by Treatment C3. The criteria of less than 5% weight loss for a practical treatment is met, and the dose response versus decay (as measured by weight difference) is at a maximum. The high degree of synergy is demonstrated in Table 18.

Straight boric acid treatments, D1 and D2, show no consistent dose response and a weight loss similar to the untreated controls, demonstrating a high degree of leaching.

TABLE 18

| | | % Decay inhibition as a % of Control | | |
|---|---|---|---|---|
| | | Tyromyces | Coniophora | Fomitopsis |
| Treatment | Retention | palustris | puteana | lilacino-gilva |
| Combined, C3 | DIPB | 93.9 | 90.5 | 99.2 |
| | 0.4% b.a.e. | | | |
| | ADBAC | | | |
| | 0.66% | | | |
| Independent, A3 | DIPB | 14.9 | 46.9 | 67.6 |
| | 0.4% b.a.e. | | | |
| Independent, B3 | ADBAC | 5.3 | 25.6 | 10.3 |
| | 0.66% | | | |
| A3 + B3 | | 19.4 | 60.5 | 70.9 |
| Synergy | | 74.5 | 30 | 28.3 |
| C3 − (A3 + B3) | | | | |

1. A composition comprising leach resistant boron in the form of a boratrane and a synergistic proportion of quaternary ammonium compound, said composition having the property of providing decay and insect resistance to wood, reconstituted wood fibers and flake and veneer products.

2. A composition as claimed in claim 1 further including triadimefon in synergistic proportion with the boratrane and quaternary ammonium compound.

3. The composition of claim 1 in the form of a stable water dilutable composition which includes a water insoluble fungicide and or insecticide.

4. The composition of claim 1 wherein the boratrane is a compound selected from the group consisting those of the general formula: 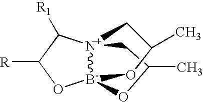
wherein R is an alkyl from C1 to C₁₋₈ or an aryl or an alkyl aryl moeity, while R₁ is H or an alkyl C₁ to C₁₈.

5. The composition of claim 1 wherein the quaternary ammonium is a compound selected from the formula: 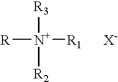
wherein R and R₁, R₂ and R₃ are the same or different and are H, C₁ to C₁₈ alkyl or C₁ to C₄ alkyl and X⁻ is an anion chosen to allow ready water solubility of the quaternary ammonium salt; and
alkyl dimethyl benzyl ammonium salts and dialky methyl benzyl ammonium salts, wherein R₂ is benzyl and R₃ is methyl, and R and R₁ may be the same or different and contain between 6 and 18 carbon atoms; or R₂ is benzyl or alkyl benzyl and R₁ and R₃ are methyl, and R contains between 8 and 18 carbon atoms; and
alkyl and dialkyl oxyethylene methyl ammonium salts of the formula: 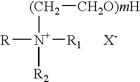
wherein R and R₁ are alkyl groups which may be the same or different and contain between 6 and 18 carbon atoms, R₂ is methyl and m is a number between 1 and 20 and X⁻ is an anion previously described; or R₁ and R₂ are methyl and R is an alkyl group between 8 and 16 carbon atoms and m is a number between 1 and 20; and
methyl and benzyl bishydroxyethyl ammonium salts of the formula: 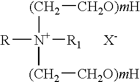
wherein R is an alkyl group which may contain between 8 and 18 carbon atoms, R₁ is methyl and m is a number between 1 and 5 and X⁻ is an anion previously described; or R₁ is a benzyl moeity and R is an alkyl group between 8 and 16 carbon atoms.

6. The composition as claimed in claim 4 herein the boratrane is 3,7-dimethyl-10-decyl-2,8,9-trioxa-5-aza-1-boratricyclo-[3.3.3.0]-undecane.

7. The composition of claim 2 wherein the boratrane is a compound selected from the group consisting those of the general formula: 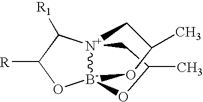
wherein R is an alkyl from C1 to C₁₋₈ or an aryl or an alkyl aryl moeity, while R₁ is H or an alkyl C₁ to C₁₈.

8. The composition of claim 3 wherein the boratrane is a compound selected from the group consisting those of the general formula: 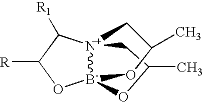
wherein R is an alkyl from C1 to C₁₈ or an aryl or an alkyl aryl moeity, while R₁ is H or an alkyl C1 to C₁₋₈.

9. The composition of claim 2 wherein the quaternary ammonium is a compound selected from the formula: 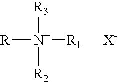
wherein R and R₁, R₂ and R₃ are the same or different and are H, C₁ to C₁₈ alkyl or C₁ to C₄ alkyl and X⁻ is an anion chosen to allow ready water solubility of the quaternary ammonium salt; and
alkyl dimethyl benzyl ammonium salts and dialky methyl benzyl ammonium salts, wherein R₂ is benzyl and R₃ is methyl, and R and R₁ may be the same or different and contain between 6 and 18 carbon atoms; or R₂ is benzyl or alkyl benzyl and R₁ and R₃ are methyl, and R contains between 8 and 18 carbon atoms; and
alkyl and dialkyl oxyethylene methyl ammonium salts of the formula: 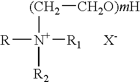
wherein R and R₁ are alkyl groups which may be the same or different and contain between 6 and 18 carbon atoms, R₂ is methyl and m is a number between 1 and 20 and X⁻ is an anion previously described; or R₁ and R₂ are methyl and R is an alkyl group between 8 and 16 carbon atoms and m is a number between 1 and 20; and
methyl and benzyl bishydroxyethyl ammonium salts of the formula: 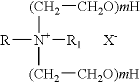
wherein R is an alkyl group which may contain between 8 and 18 carbon atoms, R₁ is methyl and m is a number between 1 and 5 and X⁻ is an anion previously described or R₁ is a benzyl moeity and R is an alkyl group between 8 and 16 carbon atoms.

10. The composition of claim 3 wherein the quaternary ammonium is a compound selected from the formula: 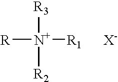
wherein R and R₁, R₂ and R₃ are the same or different and are H, C₁ to C₁₈ alkyl or C₁ to C₄ alkyl and X⁻ is an anion chosen to allow ready water solubility of the quaternary ammonium salt; and
alkyl dimethyl benzyl ammonium salts and dialky methyl benzyl ammonium salts, wherein R₂ is benzyl and R₃ is methyl, and R and R₁ may be the same or different and contain between 6 and 18 carbon atoms; or R₂ is benzyl or alkyl benzyl and R₁ and R₃ are methyl, and R contains between 8 and 18 carbon atoms; and
alkyl and dialkyl oxyethylene methyl ammonium salts of the formula: 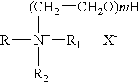
wherein R and R₁ are alkyl groups which may be the same or different and contain between 6 and 18 carbon atoms, R₂ is methyl and m is a number between 1 and 20 and X⁻ is an anion previously described; or R₁ and R₂ are methyl and R is an alkyl group between 8 and 16 carbon atoms and m is a number between 1 and 20; and
methyl and benzyl bishydroxyethyl ammonium salts of the formula: 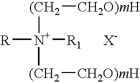
wherein R is an alkyl group which may contain between 8 and 18 carbon atoms, R₁ is methyl and m is a number between 1 and 5 and X⁻ is an anion previously described; or R₁ is a benzyl moeity and R is an alkyl group between 8 and 16 carbon atoms.

11. The composition as claimed in claim 7 wherein the boratrane is 3,7-dimethyl-10-decyl-2,8,9-trioxa-5-aza-1-boratricyclo-[3.3.3.0]-undecane.

12. The composition as claimed in claim 8 wherein the boratrane is 3,7-dimethyl-10-decyl-2,8,9-trioxa-5-aza-1-boratricyclo-[3.3.3.0]-undecane.
